(19) United States
(12) Patent Application Publication
(10) Pub. No.: US 2012/0118239 A1
(43) Pub. Date: May 17, 2012

(54) ODOR REDUCING PET BED

(75) Inventor: Robert J. Jacquart, Ironwood, MI (US)

(73) Assignee: Jacquart Fabric Products, Inc., Ironwood, MI (US)

(21) Appl. No.: 13/108,464

(22) Filed: May 16, 2011

Related U.S. Application Data
(60) Provisional application No. 61/345,373, filed on May 17, 2010.

(51) Int. Cl. A01K 29/00; B23P 19/04

(52) U.S. Cl. 119/28.5; 29/428

(57) ABSTRACT

An odor absorbing pad that includes a supply of powdered carbon fiber for absorbing odors, such as from a pet. The odor absorbing pad includes a center cushioning material that provides the required cushioning for the pad. The center cushioning material is surrounded by a liner that is air permeable and impermeable to a supply of carbon powder. The supply of carbon powder is freely distributed onto the center cushioning material and entrapped by the liner. The odor absorbing pad is configured as a pet bed such that the supply of carbon powder absorbs pet odor.

### CROSS-REFERENCE TO RELATED APPLICATION

The present application is based on and claims priority to U.S. Provisional Patent Application Serial No. 61/345,373 filed May 17, 2010, the disclosure of which is incorporated herein by reference.

### BACKGROUND OF THE INVENTION

The present disclosure generally relates to odor absorbing pads. More specifically, the present disclosure relates to a bed for use with a pet that includes freely distributed carbon particles that absorb odor from the pet.

Presently, many different types of pet beds are available that provide a place for pets to sleep in a home. Typically, pet beds include some type of cushioning material surrounded by a decorative outer cover. The cushioning material provides a comfortable place for the pet to rest while the decorative outer cover provides for a pleasing appearance for the pet bed and can be selected to match a home decor.

Although pet beds are commonly available, after an extended use of the pet bed, the outer covering material and eventually the cushioning material can take on the odor of the pet. For many pets, such as large dogs that have long fur and spend time in wet conditions, the distasteful smell of the pet bed can become overwhelming. Many pet beds can be washed in an attempt to remove the pet smell. However, the cushioning material oftentimes absorbs the pet odor and cannot be cleaned adequately to remove the odor, thus requiring disposal of the pet bed.

### SUMMARY OF THE INVENTION

The present disclosure generally relates to an odor absorbing pad, such as a pet bed. The odor absorbing pad includes a powdered carbon material that absorbs pet odor.

The odor absorbing pad generally includes a center cushioning material that provides comfort for a pet resting upon the pad. The center cushioning material can be formed from many different materials, such as a convoluted foam, a supply of fibrous material such as Dacron, or a supply of loose fiber filling. In each case, the center cushioning material is selected having a desired thickness and cushioning properties to make the pad comfortable for a pet.

The odor absorbing pad further includes a liner that surrounds the center cushioning material to contain the center cushioning material. The liner may include a zipper or other type of closure that allows the liner to completely enclose the center cushioning material. Alternatively, the center cushioning material could be applied directly to one surface of the liner and a zipper or other type of similar closure device be used to secure a top half of the pad to a bottom half of the pad. The liner is selected such that the liner is air permeable to allow air to flow between the outside of the pad and the center cushioning material contained within the pad.

In accordance with the present disclosure, a supply of carbon powder is freely distributed on or among the center cushioning material. The carbon powder is sprinkled onto or into the center cushioning material such that the carbon powder is freely distributed and generally equally distributed throughout the center cushioning material.

Once the carbon powder has been distributed onto or into the center cushioning material, the liner is closed such that the liner encases the center cushioning material including the distributed carbon powder. The liner is typically constructed such that the liner is impermeable to the carbon powder yet permeable to air flow. In this manner, air flow including pet odor can enter into the interior of the odor absorbing pad and be absorbed by the carbon powder. However, the carbon powder cannot pass through the liner such that the carbon powder is completely contained within the pad.

The size and distribution of the carbon powder within the odor absorbing pad effects the amount of odor that can be absorbed by the odor absorbing pad. In one embodiment of the disclosure, the carbon powder is individual particles having a size of between 20×50 mesh and 300×300 mesh. In addition to the size of the carbon powder, the carbon powder is supplied into the interior of the odor absorbing pad at a rate of approximately 1 to 45 grams per board foot of the pad. The carbon powder selected preferably has an absorption rate of between 45 and 85 on the CC14 index.

### BRIEF DESCRIPTION OF THE DRAWINGS

The drawings illustrate the best mode presently contemplated of carrying out the disclosure. In the drawings:

FIGS. 1a-1d illustrate a first embodiment of a pad including odor absorbing material in which the cushioning material is a convoluted foam pad;

FIGS. 2a-2d is a second embodiment of an odor absorbing pad in which the filling material is a Dacron fiber;

FIGS. 3a-3d illustrate a third embodiment in which the filling material of the pad is a loose fiber material;

FIG. 4 is a section view taken along line 4-4 of FIG. 1d;

FIG. 5 is a magnified view of FIG. 4 illustrating the distribution of the carbon powder onto the center cushioning material;

FIG. 6 is a section view taken along line 6-6 of FIG. 2d;

FIG. 7 is a magnified view of FIG. 6 illustrating the distribution of the carbon powder within the center cushioning material; and

FIG. 8 is a section view taken along line 8-8 of FIG. 3d illustrating the distribution of the carbon powder within the center cushioning material.

### DETAILED DESCRIPTION OF THE INVENTION

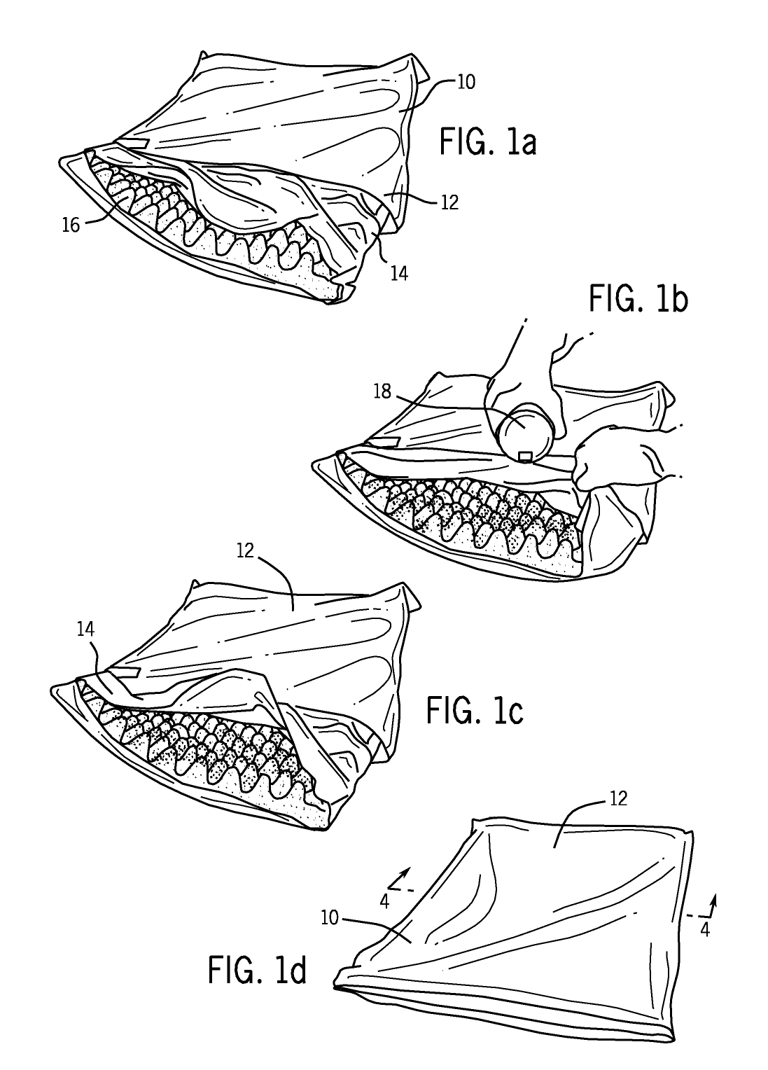

FIGS. 1a-1d illustrate a first embodiment of an odor absorbing pad 10 constructed in accordance with the present disclosure. The pad 10 is particularly useful as a pet bed, although the present disclosure should not be limited to use of the pad 10 with pets or to the use of the pad as a bed. In the embodiment of FIGS. 1a-1d, the pad 10 is particularly useful as a dog bed.

As illustrated in FIG. 1, the pad 10 includes an outer cover 12, an inner liner 14 and a center cushioning material 16. The center cushioning material 16 in the embodiment of FIGS. 1a-1d is a convoluted foam pad having a series of spaced protrusions.

The inner liner 14 that surrounds the center cushioning material 16 is specifically constructed to allow air to flow through the liner 14 while preventing small particles, such as powdered carbon, from passing through the inner liner 14.

As illustrated in FIG. 1b, a powdered carbon material from container 18 is sprinkled onto the center cushioning material 16, as illustrated. Once the powdered carbon has been sprinkled onto the center cushioning material 16, the entire pad is shaken such that the carbon powder is equally distributed throughout the pad, as illustrated in FIG. 1c. As described previously, the inner liner 14 is designed to prevent the carbon powder from passing through the inner liner 14 while allowing the odor from a pet to pass through both the inner liner 14 and the cover 12. Once the carbon powder has been equally distributed across the surface of the center cushioning material 16, the inner liner 14 and cover 12 are closed to contain the carbon powder, as illustrated in FIG. 1d.

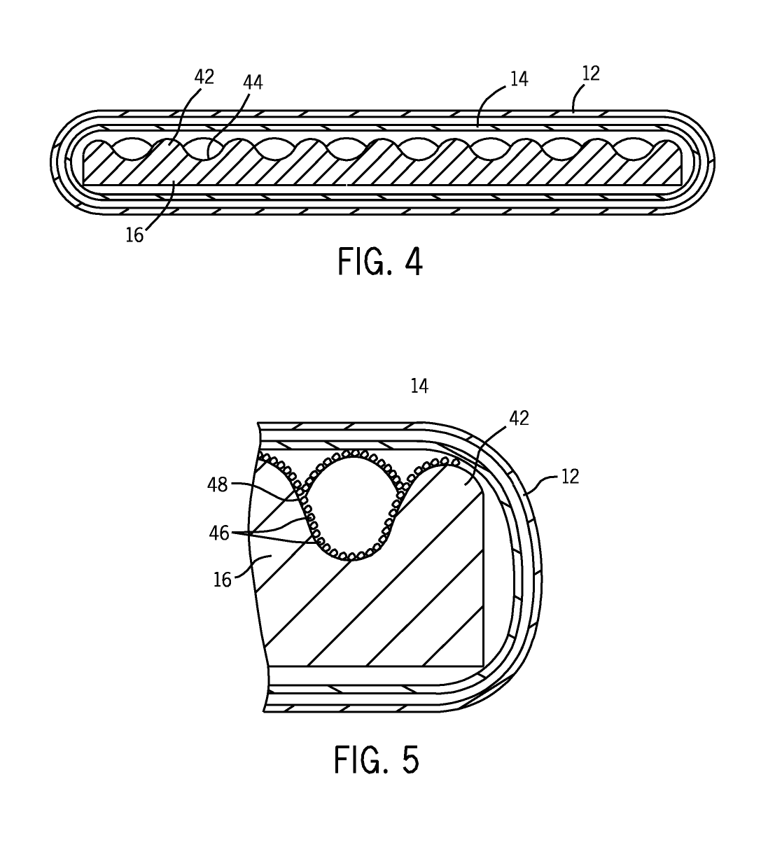

As illustrated in FIG. 4, the center cushioning material 16 is a convoluted foam pad that includes the series of protrusions 42 that are each separated by a valley 44. The series of protrusions 42 and valleys 44 provide for the required cushioning for the pad of the present disclosure.

As illustrated in FIG. 4, the inner liner 14 surrounds the center cushioning material 16. In the embodiment of FIG. 4, a decorative outer cover 12 surrounds the inner liner 14 and the center cushioning material 16. However, the decorative outer cover 12 could be eliminated while operating within the scope of the present disclosure. The decorative outer cover 12 is decorative in nature and can be colored various different colors and have different textures depending upon the user's requirements.

In the view of FIG. 5, the carbon powder has been sprinkled onto the center cushioning material 16. As illustrated in FIG. 5, the carbon powder includes individual granular pieces of carbon 46 that come to rest on the outer surface 48 of the center cushioning material 16. As described previously, the inner liner 14 is air permeable to let air flow through the inner liner 14 while being formed to prevent the carbon particles 46 from passing through the inner liner 14.

Carbon powder is known to have odor absorbing properties. In the embodiment shown in FIGS. 4 and 5, the carbon powder is freely distributed throughout the center cushioning material and comes to rest on the outer surface 48. As can be understood in FIGS. 1a-1d, the carbon powder can be easily sprinkled onto the center cushioning material 16 after the material has been formed and during the assembly of the odor absorbing pad 10.

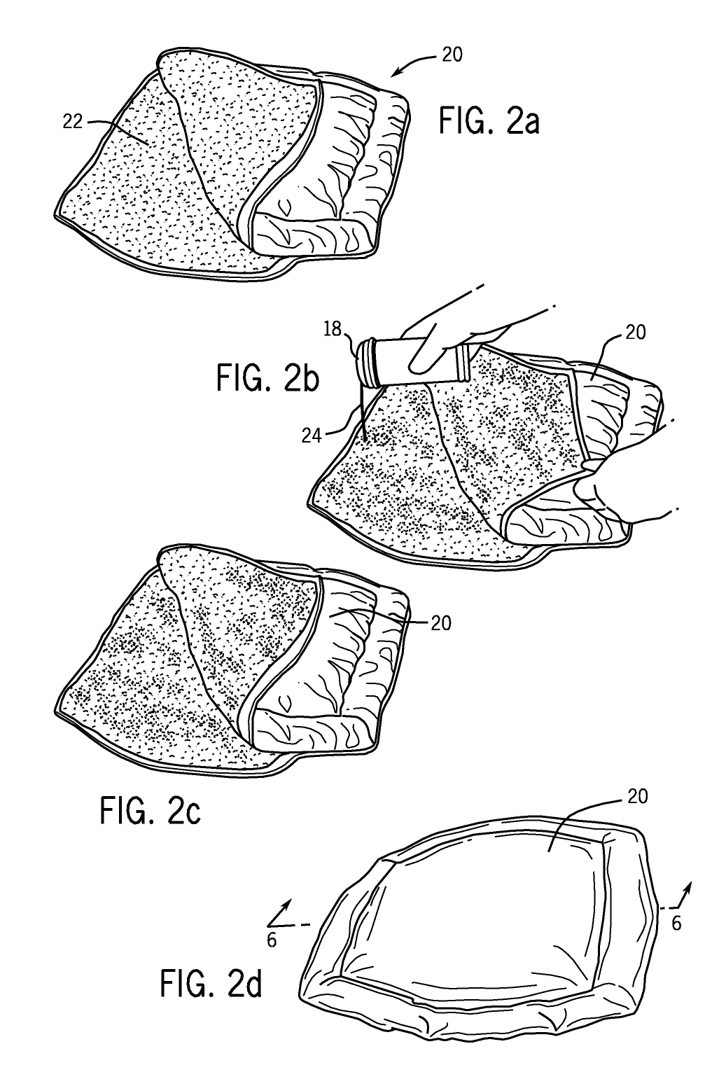

FIGS. 2a-2d illustrate a second embodiment of a pad 20. The pad 20 includes a fibrous center cushioning material 22, such as Dacron. The Dacron cushioning material 22 is attached directly to a cover of the pad 20, which may include the inner liner and outer cover.

FIG. 2b illustrates the carbon powder 24 being distributed onto the fibrous cushioning material 22 from the supply container 18. In the embodiment shown in FIGS. 2a-2d, the cover material is designed to prevent the carbon powder from passing therethrough while allowing odor from a pet or dog to enter into the interior of the pad.

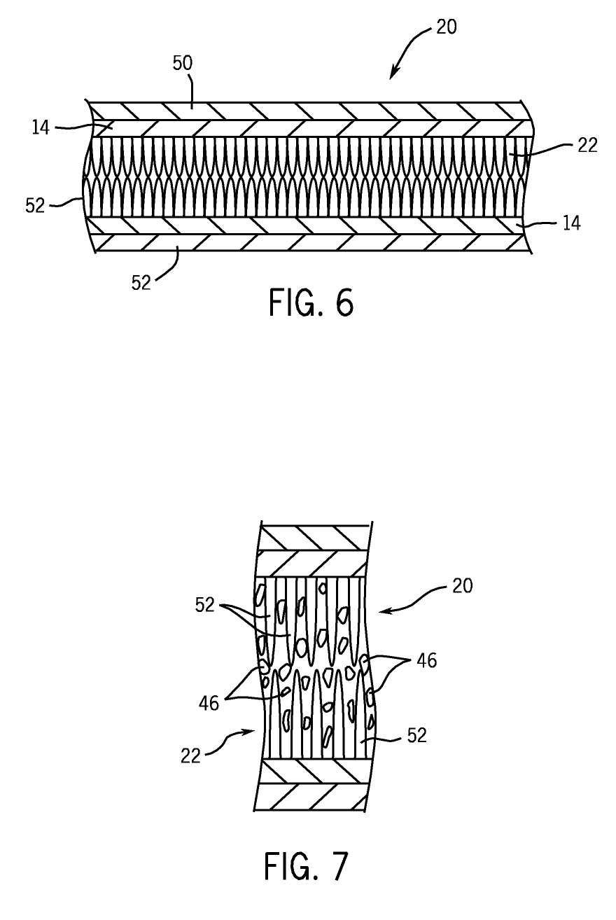

FIG. 6 illustrates a section view of the embodiment shown in FIGS. 2a-2d. As illustrated in FIG. 6, the outer cover includes the inner liner 14 and a cover material 50 connected directly thereto. The outer material 50 provides the decorative appearance for the pad 20 shown in FIGS. 2a-2d.

As previously discussed, the inner liner 14 is connected directly to the fibrous center cushioning material 22. As illustrated n FIG. 6, the center cushioning material 22 includes a plurality of individual fibers 52 that are bonded directly to the inner liner 14. The individual fibers 52 can be formed from a manufactured material, such as polyester or an equivalent material. Each of the fibers 52 provides the required cushioning for the pad when the top pad layer and the bottom pad layer are positioned on top of each other as shown in FIG. 6. The fibers 52 flex and provide cushioning for an animal positioned on the pad 20.

FIG. 7 illustrates the pad 20 after the carbon powder has been sprinkled onto the fibrous center cushioning material 22. As illustrated in FIG. 7, the individual carbon particles 46 become entrapped between the individual fibers 52 and are evenly distributed throughout the entire pad. The individual carbon particles 46 have odor absorbing properties, as previously described.

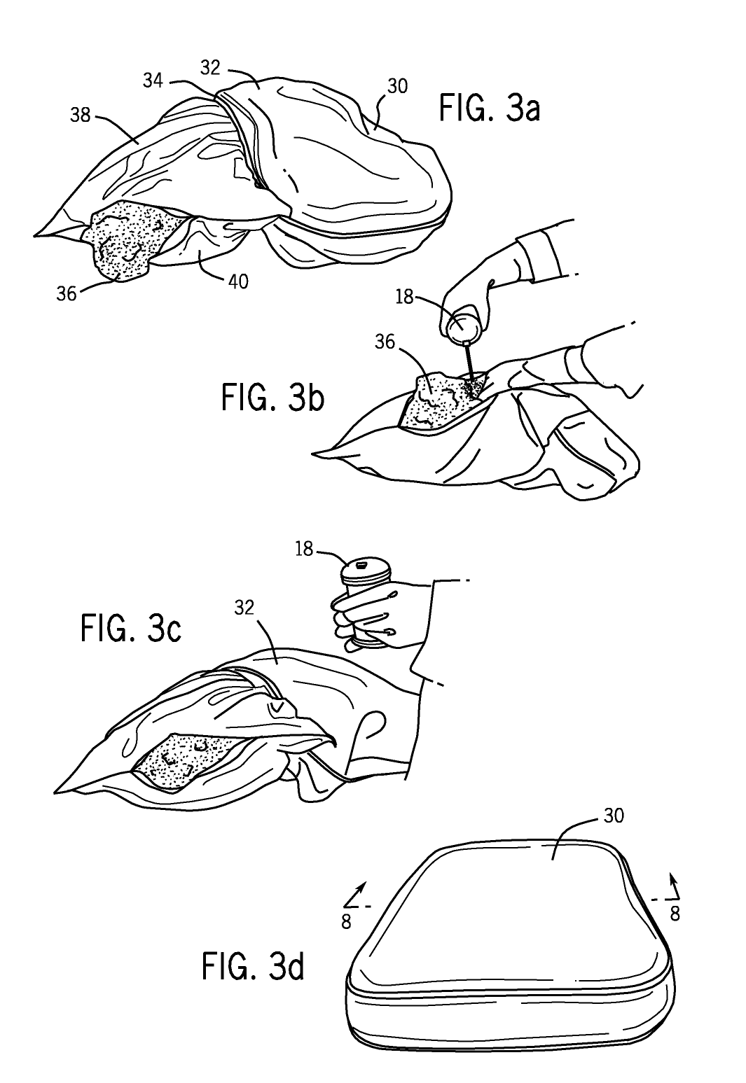

FIGS. 3a-3d illustrate yet another embodiment of a pad 30 constructed in accordance with the present disclosure. In the embodiment shown in FIG. 3a, the pad 30 includes a cover 32 having an open end 34 that receives center cushioning material. The center cushioning material in the embodiment of FIGS. 3a-3d is a loose fiber fill 36 contained within an inner liner 38. The fiber fill and inner liner 38 are similar to a pillow.

The inner liner 38 includes an opening 40 that can be opened and carbon powder poured into the fiber material 36 from the supply container 18. Once the carbon material is poured into the fiber fill, the carbon material is able to freely distribute throughout the entire fiber fill within the inner liner 38.

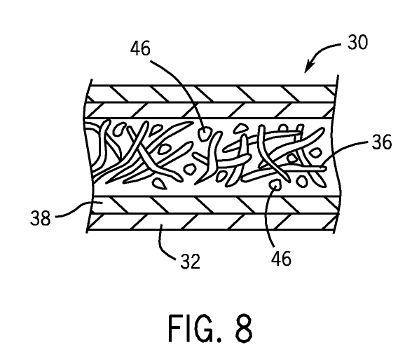

FIG. 8 illustrates a section view of the embodiment shown in FIGS. 3a-3d. In the embodiment shown in FIG. 8, the pad 30 includes the inner liner 38 and the cover 32. The inner liner 38 contains the fiber material 36. When the carbon powder is sprinkled into the fiber material 36, the carbon particles 46 are evenly distributed with the fibers of the material 36, as illustrated. The carbon particles 46 are similar to the carbon particles described with the first two embodiments of FIGS. 1 and 2.

As described in each of the embodiments shown in the drawing Figures, a carbon material is added to the padding material within the pad. The carbon material added to the center cushioning material functions to absorb odor from a pet such that when a pet sleeps or rests upon the pad, the carbon material absorbs the pet odor after the pet has left.

The absorbing function of the carbon material is dependent upon the size of the carbon material, the amount of carbon material used within each of the pads and the absorption rate of the particular carbon material. In accordance with the disclosure, the carbon material has an absorption rate of between 45 and 85 using the CC14 index. The carbon material has a size of between 20×50 mesh and 300×300 mesh. The carbon material is supplied at a rate of between 1 and 45 grams of carbon per board foot of the pad.

As discussed previously, the carbon material is preferably poured onto the padding material as shown in the Figures and allowed to evenly distribute thereupon. Although a preferred range of the carbon material is described in the specification, it should be understood that slight variations on each of these parameters could be utilized while operating within the scope of the present disclosure.

I claim:

1. An odor absorbing pad, comprising:
a center cushioning material;
a supply of carbon powder distributed on the center cushioning material; and
a liner surrounding the center cushioning material, wherein the liner is air permeable and impermeable to the carbon powder.

2. The odor absorbing pad of claim 1 wherein the supply of carbon powder is freely distributed on the center cushioning material.

3. The odor absorbing pad of claim 1 wherein the center cushioning material is convoluted foam.

4. The odor absorbing pad of claim 1 wherein the center cushioning material is a fibrous material.

5. The odor absorbing pad of claim 1 wherein the odor absorbing pad is a pet bed.

6. The odor absorbing pad of claim 1 wherein the carbon powder has a size of between 20×50 mesh and 300×300 mesh.

7. The odor absorbing pad of claim 6 wherein the carbon powder is distributed on the center cushioning material at a rate of 1 to 45 grams per board foot of the center cushioning material.

8. The odor absorbing pad of claim 1 wherein the carbon powder has an absorption rate of between 45 and 85 on the CC14 index.

9. A method of forming an odor absorbing pad, the method comprising the steps of:
supplying a pad having a center cushioning material surrounded by a liner;
opening the liner to expose the center cushioning material;
distributing a supply of carbon powder onto the center cushioning material; and
closing the liner to trap the carbon powder within the liner.

10. The method of claim 9 wherein the supply of carbon powder is freely distributed onto the center cushioning material.

11. The method of claim 9 wherein the center cushioning material is convoluted foam.

12. The method of claim 9 wherein the center cushioning material is a fibrous material.

13. The method of claim 9 wherein the odor absorbing pad is a pet bed.

14. The method of claim 9 wherein the carbon powder has a size of between 20×50 mesh and 300×300 mesh.

15. The method of claim 14 wherein the carbon powder is supplied onto the center cushioning material at a rate of 1 to 45 grams per board foot of the center cushioning material.

16. The method of claim 9 wherein the carbon powder has an absorption rate of between 45 and 85 on the CC14 scale.

17. The method of claim 9 wherein the liner is air permeable and impermeable to the carbon powder.

18. A pet bed, comprising:
a center cushioning material;
a supply of carbon powder freely distributed onto the center cushioning material; and
a liner surrounding the center cushioning material, wherein the liner is air permeable and impermeable to the carbon powder.
